(19) United States
(12) Patent Application Publication
(10) Pub. No.: US 2023/0019956 A1
(43) Pub. Date: Jan. 19, 2023

(54) PICTURE GENERATION UNIT AND HEAD-UP DISPLAY SYSTEM USING THE SAME

(71) Applicant: CONSERVE & ASSOCIATES , Inc., Taoyuan City (TW)

(72) Inventors: JIA-HONG DU, TAOYUAN CITY (TW); KUANG-TSO LUO, TAOYUAN CITY (TW)

(21) Appl. No.: 17/374,613

(22) Filed: Jul. 13, 2021

(51) Int. Cl. G02B 27/01; G09G 3/00; G02B 5/10

(52) U.S. Cl. CPC G02B 27/0101; G09G 3/002; G02B 5/10; G09G 2380/10; G02B 2027/014; B60K 2370/332; B60K 35/00

(57) ABSTRACT

A picture generation unit comprises a light emitter array that is disposed on a substrate and provides a projection imaging light. The light emitter array includes a plurality of light emitting units. Each of the light emitting units includes a plurality of mini LED chips. An electronic control unit is electrically coupled to the substrate to control the mini LED chips to generate the projection imaging light. The light emitter array may emit light as well as present controllable images simultaneously. Because the picture generation unit abandons using the conventional backlight source and the module thereof, it can effectively utilize light energy and reduce radiation heat/waste heat. A vehicular head-up display system using the picture generation unit may improve operation reliability thereof.

### 1. FIELD OF THE INVENTION

The present invention relates to a head-up display technology, particularly to a picture generation unit applied to a head-up display system.

### 2. DESCRIPTION OF THE PRIOR ART

Digital display technologies are extensively applied to many fields. The projection-based head-up display (HUD) technology is an important branch of the digital display technologies. A picture generation unit (PGU) used in HUD normally comprises a display part and a light source part, which are used to generate high-brightness, high-contrast and high-resolution pictures. The conventional PGU of the current vehicular HUD normally includes a liquid crystal display (LCD) and a backlight module. In the conventional PGU, LCD would shield as high as 92% of light. The light is further attenuated in the optical path. Thus, the brightness viewed by the user from the image on the windshield is only 1% of the brightness of the backlight. Therefore, the light utilization rate is very low in the conventional technology. Besides, the backlight module of LCD generates excessive radiation heat. Further, LED itself also generates waste heat. Both impair the reliability of a vehicular HUD device.

At present, a vehicular HUD device is required to generate a luminance of over 10000 cd/m2. In order to achieve the luminance of over 10000 cd/m2, the conventional optical design takes a measure of increasing the backlight brightness. However, such a measure results in the problems of heat emission and operation reliability in the conventional vehicular HUD device. The abovementioned problems have become focus topics in the concerned fields.

### SUMMARY OF THE INVENTION

The present invention provides a picture generation unit and a head-up display system using the same, which are applied to a vehicular HUD device, wherein the integration of light sources and images is used to increase light utilization rate, reduce radiation heat, and enhance operation reliability, and wherein the head-up display system using the same can achieve a luminance of 10000 cd/m2.

The present invention provides a picture generation unit, which is applied to a vehicular HUD device, wherein a 2-dimensional array formed by mini LEDs or smaller light emitters is used as light sources and image sources, whereby to slim the vehicular HUD device and reduce the space occupied by the vehicular HUD device.

The present invention proposes a picture generation unit, which includes a substrate; a light emitter array disposed on the substrate and outputting a projection imaging light, wherein the light emitter array includes a plurality of light emitting units, and each light emitting unit includes a plurality of mini LEDs; and an electronic control unit electrically connected with the substrate and controlling the plurality of mini LEDs to emit light and generate the projection imaging light.

The present invention also proposes a vehicular head-up display system using the abovementioned picture generation unit, which includes an optical projection system that receives the projection imaging light of the picture generation unit to generate a projection image.

### BRIEF DESCRIPTION OF THE DRAWINGS

FIG. 1 is a sectional view schematically showing a picture generation unit according to a first embodiment of the present invention.

FIG. 2 is a front view schematically showing a light emitter array of the picture generation unit according to the first embodiment of the present invention.

FIG. 3 is a front view schematically showing a light emitter array of the picture generation unit according to a second embodiment of the present invention.

FIG. 4 is a diagram schematically showing a layout of a vehicular head-up display system using a picture generation unit according to one embodiment of the present invention.

### DESCRIPTION OF THE PREFERRED EMBODIMENT

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

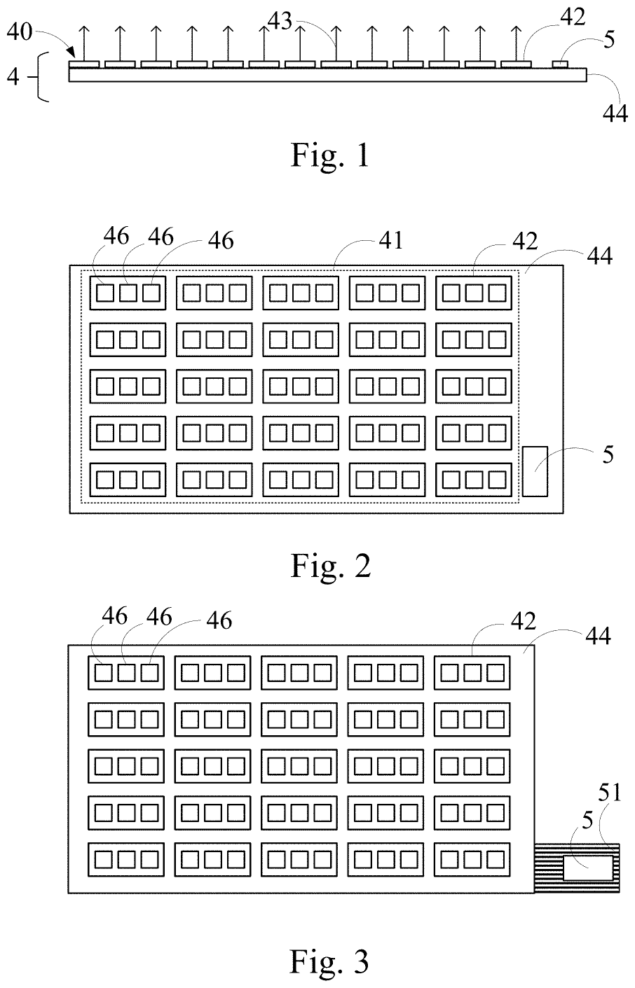

Refer to FIG. 1 and FIG. 2. The picture generation unit 4 of the present invention includes a light-output surface 40, a light emitter array 41 and a substrate 44. In one embodiment, the light emitter array 41 includes a plurality of light emitting units 42, which is disposed on the substrate 44 and arranged to form a 2-dimensional array, wherein each light emitting unit 42 includes a plurality of mini LED chips 46, such as three mini LED chips respectively emitting monochromatic lights of red color, green color and blue color. The surface of the light emitter array 41 may function as the light-output surface 40. In one embodiment, the substrate 44 may be a printed circuit board. The substrate 44 may further include circuits electrically connected with the light emitting units 42, whereby the circuits may provide power for the light emitting units 42 and transmit control signals to the light emitting units 42.

Refer to FIG. 1 and FIG. 2 again. In the embodiment that the light emitting unit 42 includes mini LEDs, the mini LEDs of each light emitting unit 42 include three mini LED chips 46 respectively emitting lights of red color, green color and blue color. Therefore, the light emitter array 41 may emit visible white light or monochromatic visible lights. The arrangement method of the mini LED chips 46 in each light emitting unit 42 is not limited by the arrangement method shown in FIG. 2. According to requirement, the mini LED chips 46 in each light emitting unit 42 may be arranged to form a triangle. The picture generation unit 4 may further include an electronic control unit 5, such as IC. The electronic control unit 5 controls each light emitting unit 42 to output the projection imaging light 43. Furthermore, the electronic control unit 5 controls the patterns, pictures, information, and generation timings of the projection imaging lights. On the other hand, the electronic control unit 5 controls the color and timing of the light emitted by the mini LED chip 46. In one embodiment, the electronic control unit 5 disposed on the substrate 44 and on a surface of the substrate 44, which is the same as the surface where the light emitting units 42 are disposed, as shown in FIG. 2. In one embodiment, the electronic control unit 5 is disposed on the substrate 44 but on a surface of the substrate 44, which is different from the surface where the light emitting units 42 are disposed (not shown in the drawings). In one embodiment, the electronic control unit 5 is disposed on another substrate 51 (as shown in FIG. 3) and electrically connected with the light emitter array 41 through the substrate 51. In one embodiment, the electronic control unit 5 is disposed on another substrate 51 (as shown in FIG. 3) and electrically connected with the substrate 44 and the substrate 51 through a connection interface (not shown in the drawings). The light emitting unit 42 may be a single module having electric-conduction pads or electric-conduction pins; the light emitting unit 42 is fixed to the substrate 44 and electrically connected with the circuit layout (not shown in the drawings) through the electric-conduction pads or electric-conduction pins.

It should be mentioned: the market-available picture generation unit of the head-up display device has a size of 60 mm×45 mm and a resolution of 800×480. It is unlikely to obtain a luminance of 10000 cd/m2 after the projection of an optical projection system unless a high-brightness light source is used. Thus, the present invention adopts a 2-dimensional array formed by mini LEDs to function as the light sources and images sources of a picture generation unit, wherein neither a TFT layer nor a liquid crystal layer exists between the light-output surface and the light source of the picture generation unit, whereby are eliminated the radiation heat and low-transmission rate optical elements of the conventional LCD backlight module. Therefore, the present invention can solve the problem of heat accumulation of a picture generation unit, increase the brightness of the projection image, raise and the operation reliability. Further, the light emitter array of the picture generation unit of the present invention can emit light and present controllable images simultaneously without using the backlight module and light uniforming structure that are required by the conventional light source. Therefore, the present invention can slim PGU, reduce the space occupied by PGU, and favor the design of interior space of a vehicle.

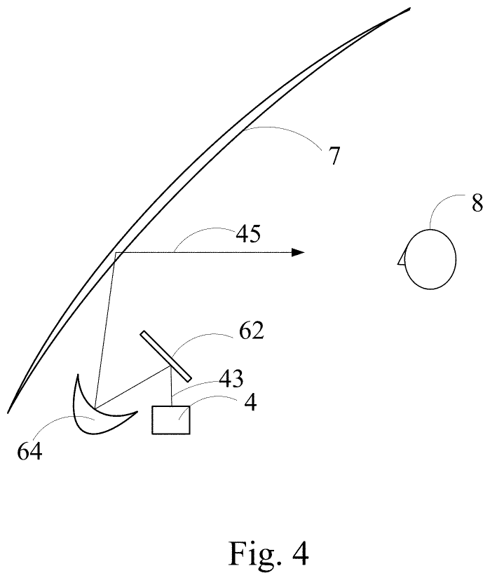

Refer to FIG. 4. FIG. 4 is a diagram schematically showing a layout of a vehicular head-up display system using a picture generation unit according to one embodiment of the present invention. The picture generation unit 4 may cooperate with an optical projection system to present a projection image 45, whereby a driver 8 may view or look up the image. In one embodiment, the picture generation unit 4 of the present invention emits a projection imaging light 43; the projection imaging light 43 is reflected by a secondary planar reflector 62 and then by an aspherical mirror 64; the windshield 7 of the vehicle receives and reflects the reflected light to present the projection image 45 on the windshield 7, whereby the driver 8 may view the image within the range of the windshield 7.

The embodiments mentioned above are to demonstrate the technical thoughts and characteristics of the present invention to enable the persons skilled in the art to understand, make, and use the present invention. However, these embodiments are only to exemplify the present invention but not to limit the scope of the present invention. Any equivalent modification or variation according to the spirit of the present invention is to be also included by the scope of the present invention.

1. A picture generation unit, comprising
a substrate;
a light emitter array, disposed on the substrate and outputting a projection imaging light, wherein the light emitter array includes a plurality of light emitting units, and each light emitting unit includes a plurality of mini light emitting diode (LED) chips; and
an electronic control unit, electrically connected with the substrate, and controlling the mini LED chips to emit light and directly generate the projection imaging light.

2. The picture generation unit according to claim 1, wherein each of the mini LED chips emits a monochromatic visible light.

3. The picture generation unit according to claim 1, wherein each of the light emitting units includes three mini LED chips respectively emitting lights of red color, green color and blue color.

4. The picture generation unit according to claim 1, wherein the electronic control unit is disposed on the substrate.

5. The picture generation unit according to claim 1, wherein the substrate includes a printed circuit board.

6. A head-up display system using the picture generation unit according to claim 1, comprising an optical projection system receiving the projection imaging light of the picture generation unit to present a projection image.

7. The head-up display system according to claim 6, wherein the optical projection system comprises a secondary planar reflector and an aspherical mirror, and the projection imaging light is received by the secondary planar reflector to be reflected onto the aspherical mirror.

8. The head-up display system according to claim 7, further comprising a windshield receiving the projection imaging light reflected by the aspherical mirror.
